(19) United States
(12) Patent Application Publication
(10) Pub. No.: US 2025/0324184 A1
(43) Pub. Date: Oct. 16, 2025

(54) SYSTEM AND METHOD FOR AN AUDIO PRIVACY COVER FOR AUDIO HEADPHONES

(71) Applicant: Dell Products LP, Round Rock, TX (US)

(72) Inventors: Peng Lip Goh, Singapore (SG); Deeder M. Aurongzeb, Austin, TX (US); Eng Kang Chng, Singapore (SG)

(73) Assignee: Dell Products LP, Round Rock, TX (US)

(21) Appl. No.: 18/634,677

(22) Filed: Apr. 12, 2024

(51) Int. Cl. H04R 1/08; H04R 1/28; H04R 1/34

(52) U.S. Cl. CPC H04R 1/083; H04R 1/2892; H04R 1/342; H04R 2201/107; H04R 2430/01

(57) ABSTRACT

A set of audio headphones operatively coupled to an information handling system includes a digital signal processor (DSP), a headphone power management unit (PMU) to provide power to the DSP, a first ear cup with a first speaker and a second ear cup with a second speaker operatively coupled to each other via a headband, and a mouth privacy cover operatively coupled to the first ear cup at a first end of the mouth privacy cover and operatively coupled to the second ear cup at a second end of the mouth privacy cover, the mouth privacy cover having a microphone built into the mouth privacy cover and operatively coupled to the DSP via a cover receiver with electrical contacts formed on the mouth privacy cover and interfacing with ear cup contact pads formed on at least one of the first ear cup and second ear cup.

### FIELD OF THE DISCLOSURE

The present disclosure generally relates to wired or wireless audio headphones. More specifically, the present specification relates to an audio privacy cover for a microphone of a pair of wired or wireless audio headphones.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more applications such as work productivity applications, teleconference applications, or a gaming application. Further, the information handling system may be operatively coupled to an audio input/output device such as a set of headphones.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system including a pair of headphones with a mouth privacy cover operatively coupled to the information handling system according to an embodiment of the present disclosure;

FIG. 2 is a graphic and block diagram illustrating an information handling system operatively coupled to a pair of headphones with a mouth privacy cover according to an embodiment of the present disclosure;

FIG. 3A is a graphic diagram depicting a front perspective view of a mouth privacy cover operatively couplable to a pair of headphones according to an embodiment of the present disclosure;

FIG. 3B is a graphic diagram depicting a rear perspective view of a mouth privacy cover operatively couplable to a pair of headphones according to another embodiment of the present disclosure;

FIG. 4 is a graphic diagram depicting a mouth privacy cover being operatively coupled to contact pads of a pair of headphones via one or more receivers with electrical contacts of the mouth privacy cover according to another embodiment of the present disclosure; and

FIG. 5 is a flow chart showing a method of assembling a pair of headphones including a mouth privacy cover according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems may be operatively coupled to a plurality of input and output devices that allow a user to interact with the information handling system. The types of input may include cursor movement and selection input from a mouse and/or trackpad, keystroke input from a keyboard, and audio input into a microphone, and audio output at a speaker or other speaker driver. An example of an audio input/output peripheral device includes headphones such as a headset. The set of headphones may include a set of ear cups that either rest on top of or cover a user's ears when the set of headphones is worn. The set of ear cups may be operatively coupled to each other using a headband so that the set of headphones may rest on the user's head when in use.

However, the set of audio headphones may often be used in environments where others can hear a user's conversation, such as a teleconference with other online users, when the user is using a microphone associated with the set of headphones. For example, where a user is a telemarketer that engages in conversations via a telephone connection or via voiceover internet protocol (VOIP), other telemarketers may hear the conversations and the noise associated with multiple conversations engaged in by multiple telemarketers may be distracting without physical barriers placed between the users of the sets of headphones in order to reduce the noise heard by any individual telemarketer. Other examples exist where a user may be in an open office space with other office workers capable of hearing, sometimes, personal and/or proprietary conversations when the user is using the set of headphones. Aside from the potential annoyance of hearing the user using the microphone on the set of headphones, user privacy for conversations using headphones may be desired.

The present specification describes a set of audio headphones that may be operatively coupled to an information handling system to receive audio data from the information handling system and send audio data originating from a microphone on the set of headphones to the information handling system. The set of headphones may include a digital signal processor (DSP), a headphone power management unit (PMU) to provide power to the DSP to process audio input via a microphone or audio output via headphone speakers. A first ear cup with a first speaker and a second ear cup with a second speaker operatively coupled to each other via a headband may form the headphones as a headset. In embodiments herein, the set of headphones also includes a mouth privacy cover operatively coupled to the first ear cup at a first end of the mouth privacy cover. In some embodiments, the mouth privacy cover is also operatively coupled to the second ear cup of the headphones at a second end of the mouth privacy cover. The mouth privacy cover comprising a microphone built into the mouth privacy cover and operatively coupled to the DSP via one or more receivers with electrical contacts formed on the mouth privacy cover and interfacing with ear cup contact pads formed on at least one of the first ear cup and second ear cup. In an embodiment, the mouth privacy cover includes hinges that allow a mouth privacy cover boom portion of the mouth privacy cover to be angled up or down to align the mouth privacy cover with a user's mouth to cover the user's mouth to provide more privacy for the user's voice. This allows the user's mouth to be covered by the mouth privacy cover to reduce the ability of others to hear the user's conversation. In an embodiment, the mouth privacy cover may be shaped as a crescent shape or curved shape that reflects the user's voice back within the space between the mouth privacy cover and the user's mouth. In a further embodiment, the mouth privacy cover may include a concave interior surface that concentrate the user's voice within the space between the mouth privacy cover and the user's mouth. In an embodiment, the size of a boom portion of the mouth privacy cover may be sufficient to cover the user's mouth when aligned in front of the user's mouth so that the user's voice is reflected back and largely captured within the space between the mouth privacy cover and the user's mouth to limit no sound leakage of the user's voice while the user is talking into the microphone. In an embodiment, the adjustable boom portion of the mouth privacy cover may be made of plastic or other lightweight material.

In an embodiment, a latch, magnets, or interference fit structures may be formed on at least one side of the mouth privacy cover to latch the at least one side of the mouth privacy cover to at least one of the first ear cup and second ear cup. This latch may secure the mouth privacy cover to the set of headphones on the one or more contact pads when the user is, for example, engaged in a conversation while also engaged in a physical activity such as walking, running, or the like. When not in use, the user may remove the mouth privacy cover from the set of headphones by unlatching the latch or disengaging magnets and pulling the mouth privacy cover away from the set of headphones.

In an embodiment, the microphone formed in the mouth privacy cover may be operatively coupled to the DSP via the receiver with electrical contacts of the mouth privacy cover operatively and electrically coupling with one or more contact pads of the audio headphones. In an example embodiment, the first ear cup may include one or more first ear cup contact pads and/or the second ear cup may include one or more second ear cup contact pads that each interface with one or more first cover receiver with electrical contacts and one or more second cover receiver with electrical contacts formed at an end of the mouth privacy cover, respectively, to transmit audio data from the microphone to the DSP. The first or second receivers with electrical contacts may be a socket, cavity, or attachment space at one or both ends of the mouth privacy cover to operatively couple with the first or second ear cup contact pads of the headset. In an embodiment, the first ear cup contact pads, second ear cup contact pads, first cover receiver with electrical contacts, and second cover receiver with electrical contacts may be magnetic or incorporate magnets into a housing of the first and second ear cups and/or mouth privacy cover to allow a user to secure the mouth privacy cover to the headphones and electrically couple the microphone to the DSP via the ear cup contacts and cover receivers with electrical contacts. In an embodiment, an interference fit between the mouth privacy cover and each of the first ear cup and second ear cup may be formed at the receiver or receivers with electrical contacts of the mouth privacy cover and the contact pads of the headset so that the user may couple the mouth privacy cover to the headphones.

In an embodiment, the mouth privacy cover may include a touch audio sensor formed on, for example, a surface of the mouth privacy cover. In an embodiment, the touch audio sensor may receive touch input from a user to adjust audio characteristics from the DSP or other hardware controller of the audio output from one or more speakers formed into at least one of the first ear cup and second ear cup or audio input from a microphone such as mute or volume. In an embodiment, one or more light-emitting diodes (LEDs) may be formed into the mouth privacy cover to indicate to the user a status of the adjustments to the audio characteristics of the audio output or audio input that have been made via the touch audio sensor.

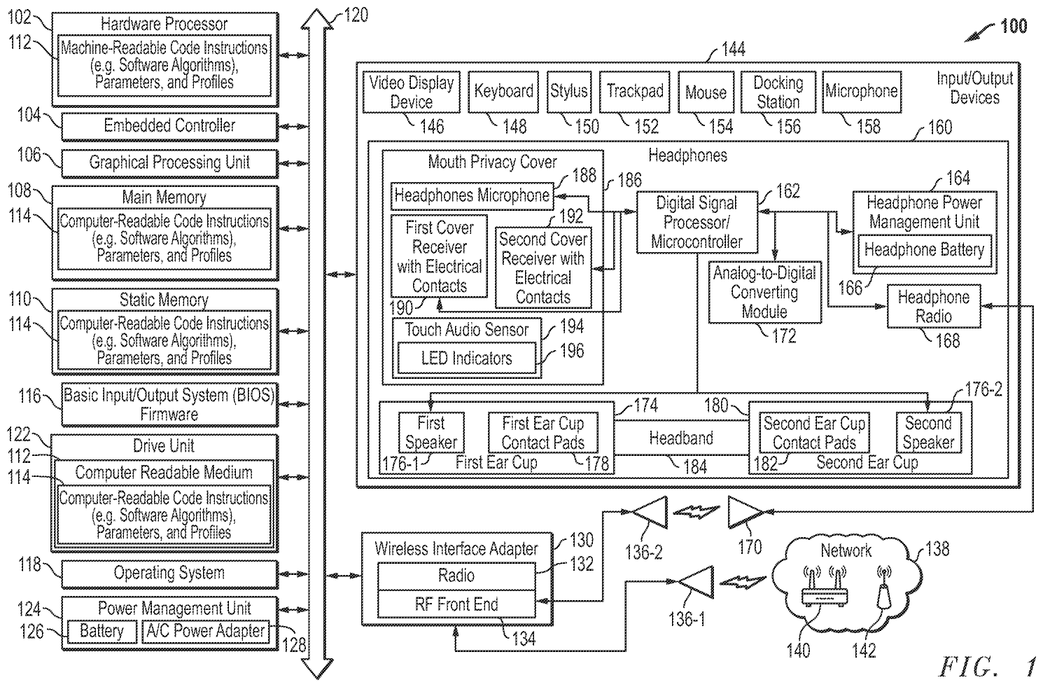

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 140, a base station transceiver, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 108, (volatile (e.g., random-access memory, etc.), or static memory 110, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, or any combination thereof. Additional components of the information handling system 100 may include one or more storage devices such as static memory 110 or drive unit 122. The information handling system 100 may include or interface with one or more communications ports for communicating with external devices, as well as various input and output (I/O) devices 144, such as a docking station 156, a mouse 154, a trackpad 152, a stylus 150, a keyboard 148, a video/graphics display device 146, a microphone 158, a set of headphones 160, wireless earphones, headset, etc., or any combination thereof. Portions of an information handling system 100 may themselves be considered information handling systems 100. It is appreciated that the headphones 160 described herein that are operatively couplable to the information handling system either via a wired or wireless connection with the headphones 160 allows a user to be provided audio output to the user via a speaker and provide audio input from the user to headphones microphone 188 of the headphones 160.

Information handling system 100 may include devices or modules that embody one or more of the devices or execute instructions for one or more systems and modules. The information handling system 100 may execute instructions (e.g., software algorithms), parameters, and profiles 114 that may operate on servers or systems, remote data centers, or on-box in individual client information handling systems according to various embodiments herein. In some embodiments, it is understood any or all portions of instructions (e.g., software algorithms), parameters, and profiles 114 may operate on a plurality of information handling systems 100.

The information handling system 100 may include the hardware processor 102 such as a central processing unit (CPU). Any of the processing resources may operate to execute code that is either firmware or software code. Moreover, the information handling system 100 may include memory such as main memory 108, static memory 110, and disk drive unit 122 (volatile (e.g., random-access memory, etc.), nonvolatile memory (read-only memory, flash memory etc.) or any combination thereof or other memory with computer readable medium 112 storing instructions (e.g., software algorithms), parameters, and profiles 114 executable by the hardware processor 102, EC 104, GPU 106, or any other hardware processing device. The information handling system 100 may also include one or more buses 120 operable to transmit communications between the various hardware components such as any combination of various I/O devices 144 as well as between hardware processors 102, an EC 104, the operating system (OS) 118, the basic input/output system (BIOS) 116, the wireless interface adapter 130, or a radio module, among other components described herein. In an embodiment, the hardware processor 102, EC 104, and/or GPU 106 may execute one or more bus drivers in order to transmit this data between the information handling system 100 and the input/output devices 144 described herein. In an embodiment, the information handling system 100 may be in wired or wireless communication with the I/O devices 144 such as the headphones 160, a keyboard 148, a mouse 154, video display device 146, stylus 150, or trackpad 152 among other peripheral devices via the wireless interface adapter 130.

As described herein, the information handling system 100 further includes a video/graphics display device 146. The video/graphics display device 146 in an embodiment may function as a liquid crystal display (LCD), an organic light emitting diode (OLED), a flat panel display, or a solid-state display. It is appreciated that the video/graphics display device 146 may be wired or wireless and may be an external video/graphics display device 146 that allows a user to increase the desktop area by extending the desktop in an embodiment. Additionally, as described herein, the information handling system 100 may include or be operatively coupled to a cursor control device (e.g., a trackpad 152, or gesture or touch screen input), a stylus 150, and/or a keyboard 148, among others that allows the user to interface with the information handling system 100 via the video/graphics display device 146. Information handling system 100 may also be operatively coupled to a peripheral device 144 such as the headphones 160 or other smart peripheral device having a hardware processing device such as a hardware processor, microcontroller, or other hardware processing resource and which may be further operatively coupled to one or more additional peripheral devices 144. Various drivers and hardware control device electronics may be operatively coupled to operate the I/O devices 144 according to the embodiments described herein. The present specification contemplates that the I/O devices 144 may be wired or wireless.

A network interface device of the information handling system 100 shown as wireless interface adapter 130 can provide connectivity among devices such as with Bluetooth® or to a network 138, e.g., a wide area network (WAN), a local area network (LAN), wireless local area network (WLAN), a wireless personal area network (WPAN), a wireless wide area network (WWAN), or other network. The wireless interface adapter 130 of the information handling system 100 may be wireless coupled to headphones 160 via a Bluetooth® or Bluetooth® Low Energy (BLE) protocol in an example embodiment. In embodiments described herein, the wireless interface device 130 with its radio 132, RF front end 134 and antenna 136-1, 136-2 is used to communicate with the wireless peripheral devices via, for example, a Bluetooth® or BLER protocols. In an embodiment, the WAN, WWAN, LAN, and WLAN may each include an AP 140 or base station 142 used to operatively couple the information handling system 100 to a network 138. In a specific embodiment, the network 138 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 130 may include one or more radio frequency (RF) subsystems (e.g., radio 132) with transmitter/receiver circuitry, modem circuitry, one or more antenna radio frequency (RF) front end circuits 134, one or more wireless controller circuits, amplifiers, antennas 136-1, 136-2 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 138 may communicate voice, video, or data over the network 138. Further, the instructions 114 may be transmitted or received over the network 138 via the network interface device or wireless interface adapter 130.

The information handling system 100 may include a set of instructions 114 that may be executed to cause the computer system to perform any one or more of the methods or computer-based functions disclosed herein. For example, instructions 114 may be executed by a hardware processor 102, GPU 106, EC 104 or any other hardware processing resource and may include software agents, or other aspects or components used to execute the methods and systems described herein. Various software modules comprising application instructions 114 may be coordinated by an OS 118, and/or via an application programming interface (API) include a unified device API described herein. An example OS 118 may include Windows®, Android®, and other OS types. Example APIs may include Win 32, Core Java API, or Android APIs.

In an embodiment, the information handling system 100 may include a disk drive unit 122. The disk drive unit 122 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 108 and static memory 110 may also contain a computer-readable medium for storage of one or more sets of machine-readable code instructions, parameters, or profiles 114 described herein. The disk drive unit 122 or static memory 110 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 108, the static memory 110, and/or within the disk drive 122 during execution by the hardware processor 102, EC 104, or GPU 106 of information handling system 100.

Main memory 108 or other memory of the embodiments described herein may contain computer-readable medium (not shown), such as RAM in an example embodiment. An example of main memory 108 includes random access memory (RAM) such as static RAM (SRAM), dynamic RAM (DRAM), non-volatile RAM (NV-RAM), or the like, read only memory (ROM), another type of memory, or a combination thereof. Static memory 110 may contain computer-readable medium (not shown), such as NOR or NAND flash memory in some example embodiments. The applications and associated APIs, for example, may be stored in static memory 110 or on the disk drive unit 122 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 124 (a.k.a. a power supply unit (PSU)). The PMU 124 may include a hardware controller and executable machine-readable code instructions to manage the power provided to the components of the information handling system 100 such as the hardware processor 102 and other hardware components described herein. The PMU 124 may control power to one or more components including the one or more drive units 122, the hardware processor 102 (e.g., CPU), the EC 104, the GPU 106, a video/graphic display device 146, or other wired I/O devices 144 such as the mouse 154, the stylus 150, the keyboard 148, a wired version of the headphones 160 described herein, and the trackpad 152 and other components that may require power when a power button has been actuated by a user. In an embodiment, the PMU 124 may monitor power levels and be electrically coupled to the information handling system 100 to provide this power. The PMU 124 may be coupled to the bus 120 to provide or receive data or machine-readable code instructions. The PMU 124 may regulate power from a power source such as the battery 126 or AC power adapter 128. In an embodiment, the battery 126 may be charged via the AC power adapter 128 and provide power to the components of the information handling system 100, via wired connections as applicable, or when AC power from the AC power adapter 128 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 is operatively coupled to a set of headphones 160. For purposes of the present specification, the set of headphones 160 may be referred to as a “set of headphones” due to the use of a first ear cup 174 and a second ear cup 180 that are to be placed over a user's left and right ears, respectively. However, the set of headphones 160 may also be referred to herein as headphones 160, a headset, and similar terms. In an embodiment, the headphones 160 may be wired headphones 160 that are operatively coupled to the information handling system 100 via a wired connection via, for example, a universal serial bus (USB) connector at a USB port formed into a housing of the information handling system 100. In an embodiment, the headphones 160 may be wireless headphones 160 that are wirelessly operatively coupled to the information handling system 100 via the headphone radio 168 and headphone antenna 170 transceiving data via use of the wireless interface adapter 130, radio 132, RF front end 134, and antenna 136-2 of the information handling system 100. It is appreciated that audio data may be transmitted from the information handling system 100, wirelessly, to a digital signal processor (DSP) 162 of the headphones 160 for transmission to one or more speakers 176-1, 176-2 formed into the first ear cup 174 and second ear cup 180, respectively. Additionally, it is appreciated that the DSP 162 may execute computer-readable program code instructions of an analog-to-digital converting module 172 to convert analog audio signals from a headphone microphone 188 formed into a mouth privacy cover 186 to a digital format for transmission to the information handling system 100 via the wireless interface adapter 130. This allows the user to receive output from the headphones 160 and provide input to the headphones 160.

As described herein, the headphones 160 include a headphones PMU 164. The headphones PMU 164 may include a hardware controller and executable machine-readable code instructions to manage the power provided to the components of the headphones 160 such as the DSP 162 and other hardware components described herein. The headphones PMU 164 may control, via the DSP 162, power to one or more components including the first speaker 176-1, the second speaker 176-2, the DSP 162, the headphone microphone 188, a touch audio sensor 194 formed onto the mouth privacy cover 186, along with other hardware components formed into the headphones 160 such as the headphone radio 168. The headphones PMU 164 may regulate power from a power source such as the headphone battery 166 in an embodiment. In an embodiment, the headphones PMU 164 may regulate power provided to the headphones 160 via a wired connection to the information handling system 100.

As described herein, the headphones 160 may include a first ear cup 174 and a second ear cup 180 that are to be placed over or onto the user's left and right ears, respectively. In an embodiment, each of the first ear cup 174 and second ear cup 180 may include a first speaker 176-1 and second speaker 176-2, respectively, in order to provide the audio output to the user as described herein. The first ear cup 174 and second ear cup 180 may be operatively coupled to a headband 184 such that, when worn by a user, the headphones 160 may rest on the user's head with the first ear cup 174 and second ear cup 180 positioned onto or over the user's ears as described. In an embodiment, the headband 184 may include an extending portion that allows the distance between a top portion of the headband 184 to be drawn closer or further away from each of the first ear cup 174 and second ear cup 180 thereby allowing a user to customize the fit of the headphones 160 on the user's head.

In an embodiment, each of the first ear cup 174 and second ear cup 180 may include first ear cup contact pads 178 and second ear cup contact pads 182 respectively. Each of the first ear cup contact pads 178 and second ear cup contact pads 182 may be operatively coupled to the DSP 162 of the headphones 160 in order to transmit data from the headphone microphone 188 formed in the mouth privacy cover 186 to the DSP 162. Accordingly, the mouth privacy cover 186 may include corresponding first cover receiver with electrical contacts 190 and second cover receiver with electrical contacts 192 that interface with the first ear cup contact pads 178 and second ear cup contact pads 182, respectively, in order to transmit the audio signals from the headphone microphone 188 to the DSP 162 as well as provide power from the DSP 162/headphones PMU 164 to the headphone microphone 188. It is appreciated that engaging the first ear cup contact pads 178 with the first cover receiver with electrical contacts 190 and the second ear cup contact pads 182 with the second cover receiver with electrical contacts 192 may include the use of a latch or other coupling device that operatively couples a left side of the mouth privacy cover 186 to the first ear cup 174 and a right side of the mouth privacy cover 186 to the second ear cup 180. In an embodiment a single set of ear cup contact pads 178 or 182 may be used to be operatively coupled to a single set of cover receiver with electrical contacts 190 or 192 with the transmission of audio data and power being competed via these single sets of ear cup contact pads 178 or 182 and cover receiver with electrical contacts 190 or 192.

In an embodiment, the mouth privacy cover 186 of the headphones 160 may include a touch audio sensor 194. The touch audio sensor 194 may be any type of touch controller that receives touch input from the user of the headphones 160 in order to adjust audio characteristics of the audio output from the speakers 176-1, 176-2. For example, the touch audio sensor 194 may include any capacitive touch, resistive touch, light detector, or other device that may be used to detect the user's touch. These adjustments to the audio characteristics of the audio output may include pausing the audio (e.g., via a single touch), increasing a volume of the audio (e.g., via dragging the user's finger over the touch audio sensor 194 in a first direction), decreasing a volume of the audio (.e.g., via dragging the user's finger over the touch audio sensor 194 in a second direction), skipping audio tracks among a plurality of audio tracks (e.g., double tapping the touch audio sensor 194), and replaying a track (e.g., triple tapping the touch audio sensor 194). It is appreciated that the touch audio sensor 194 may be arranged to receive any type of touch input from the user to adjust the characteristics of the audio output and the present specification contemplates that these other types of touch input at the touch audio sensor 194 by the user. In an embodiment, a number of LED indicators 196 may be formed on the mouth privacy cover 186, for example, next to the touch audio sensor 194 that indicates a status of the adjustments made to the audio output at the speakers 176-1, 176-2. In an example embodiment, a series of LED indicators 196 may be arranged next to the touch audio sensor 194 such that successive illumination of the LED indicators 196 indicates a volume level of the audio output at the speakers 176-1, 176-2.

In an embodiment, the mouth privacy cover 186 includes privacy cover hinges formed on the mouth privacy cover 186 that allow the mouth privacy cover 186 to be angled up or down to align the mouth privacy cover 186 with a user's mouth to cover the user's mouth to prevent the user's voice from being heard. This allows the user's mouth to be covered by the mouth privacy cover 186 so that the ability of others to hear the user's conversation is inhibited or eliminated. In an embodiment, these privacy cover hinges may be formed at or close to a location where the first ear cup contact pads 178 engage with the first cover receiver with electrical contacts 190 and where the second ear cup contact pads 182 engages with the second cover receiver with electrical contacts 192. In an embodiment, the privacy cover hinges may include an internal space through which electrical leads may be passed from the microphone to the first cover receiver with electrical contacts 190 and second cover receiver with electrical contacts 192 to allow data and power transmission from and to the first cover receiver with electrical contacts 190 and second cover receiver with electrical contacts 192 as described herein.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

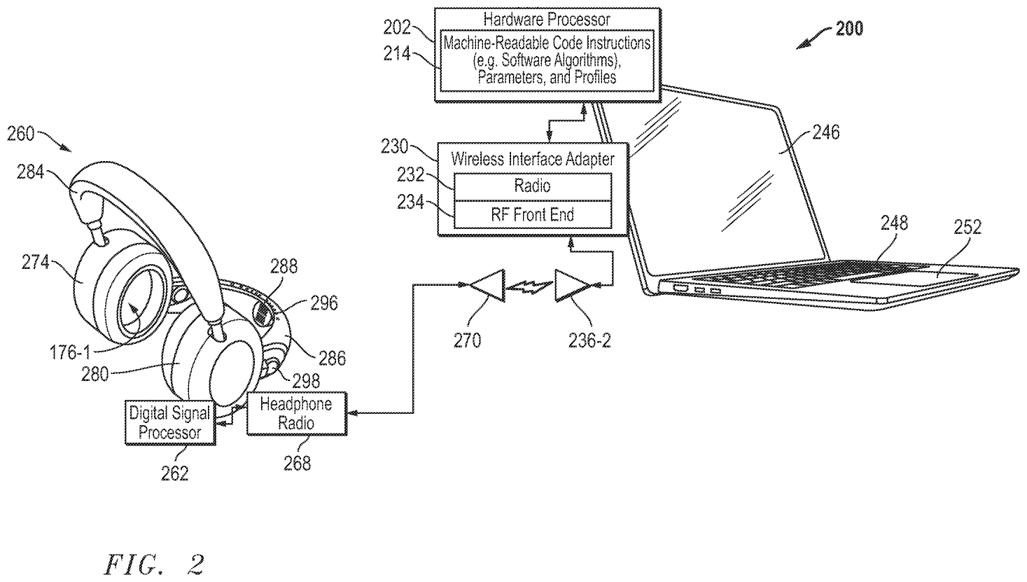

FIG. 2 is a graphic and block diagram illustrating an information handling system 200 operatively coupled to a pair of audio headphones 260 with a mouth privacy cover 286 according to an embodiment of the present disclosure. For purposes of the present specification, the terms audio headphones, headphones, set of headphones, or headset may be used to describe the audio headphones 260 in various embodiments. FIG. 2 shows, in an example embodiment, the audio headphones 260 are wireless headphones that are operatively coupled to the information handling system 200 via use of a headphone radio 268 and headphone antenna 270 communicating with the radio 232, RF front end 234, and wireless antenna 236-2 of the information handling system 200. In an embodiment, the DSP 262 may coordinate the wireless pairing of the audio headphones 260 to the information handling system 200 via, for example, using a Bluetooth® or BLE wireless protocol. The hardware processor 202 may also include machine-readable code instructions, parameters, and profiles 214 that, when executed, allows the information handling system 200 to engage in this wireless pairing of the audio headphones 260 to the information handling system 200.

As described herein, the set of audio headphones 260 may be referred to as a “set of headphones” due to the use of a first ear cup 274 and a second ear cup 280 that are to be placed over a user's left and right ears, respectively. However, the set of headphones 260 may also be referred to herein as headphones 260, a headset, and similar terms. In an embodiment, the headphones 260 may be wired headphones 260 that are operatively coupled to the information handling system 200 via a wired connection via, for example, a universal serial bus (USB) connector at a USB port formed into a housing of the information handling system 200 instead of being operatively coupled to the information handling system 200 via a wireless connection shown in FIG. 2.

It is appreciated that audio data may be transmitted from the information handling system 200, wirelessly, to the DSP 262 of the headphones 260 for transmission to one or more speakers 276-1 (a second speaker in the second ear cup 280 not shown) formed into the first ear cup 274 and second ear cup 280, respectively. Additionally, it is appreciated that the DSP 262 may execute computer-readable program code instructions of an analog-to-digital converting module (not shown) or a headphone analog to digital (A/D) converter hardware to convert analog audio signals from a headphone microphone 288 formed into a mouth privacy cover 286 to a digital format for transmission to the information handling system 200 via the wireless interface adapter 230. This allows the user to receive output from the headphones 260 and provide input to the headphones 260.

As described herein, the headphones 260 include a headphones PMU (not shown). The PMU may include a hardware controller and executable machine-readable code instructions to manage the power provided to the components of the headphones 260 such as the DSP 262 and other hardware components described herein. The headphones PMU may control, via the DSP 262, power to one or more components including the first speaker 276-1, the second speaker (not shown), the DSP 262, the headphone microphone 288, a touch audio sensor (not shown) formed onto the mouth privacy cover 286, along with other hardware components formed into the headphones 260 such as the headphone radio 268. The headphones PMU may regulate power from a power source such as the headphone battery (not shown) in an embodiment. In an embodiment, the headphones PMU may regulate power provided to the headphones 260 via a wired connection to the information handling system 200.

As described herein, the headphones 260 may include a first ear cup 274 and a second ear cup 280 that are to be placed over or onto the user's left and right ears, respectively. In an embodiment, each of the first ear cup 274 and second ear cup 280 may include a first speaker 276-1 and second speaker, respectively, in order to provide the audio output to the user as described herein. The first ear cup 274 and second ear cup 280 may be operatively coupled to a headband 284 such that, when worn by a user, the headphones 260 may rest on the user's head with the first ear cup 274 and second ear cup 280 positioned onto or over the user's ears as described. In an embodiment, the headband 284 may include an extending portion that allows the distance between a top portion of the headband 284 to be drawn closer or further away from each of the first ear cup 274 and second ear cup 280 thereby allowing a user to customize the fit of the headphones 260 on the user's head.

In an embodiment, each of the first ear cup 274 and second ear cup 280 may include first ear cup contact pads (not shown) and second ear cup contact pads (not shown) respectively. Because the mouth privacy cover 286 is shown to be operatively coupled to the headphones 260 in FIG. 2, these first and second ear cup contact pads are not viewable. Each of the first ear cup contact pads and second ear cup contact pads may be operatively coupled to the DSP 262 of the headphones 260 in order to transmit data from the headphone microphone 288 formed in the mouth privacy cover 286 to the DSP 262. Accordingly, the mouth privacy cover 286 may include corresponding first cover receiver with electrical contacts (not shown) and second cover receiver with electrical contacts (not shown) that interface with the first ear cup contact pads and second ear cup contact pads, respectively, in order to transmit the audio signals from the headphone microphone 288 to the DSP 262 as well as provide power from the headphones PMU to the headphone microphone 288 and mouth privacy cover 286. Again, because the mouth privacy cover 286 is shown to be operatively coupled to the headphones 260 in FIG. 2, these first and second cover receiver with electrical contacts are not shown. It is appreciated that engaging the first ear cup contact pads with the first cover receiver with electrical contacts and the second ear cup contact pads with the second cover receiver with electrical contacts may include the use of a latch, magnets (of opposite polarity or a magnet and ferromagnetic material), an interference fit, screws, bolts, keyways, or other coupling device that operatively couples a left side of the mouth privacy cover 286 to the first ear cup 274 and a right side of the mouth privacy cover 286 to the second ear cup 280. In an embodiment a single set of ear cup contact pads may be used to be operatively coupled to a single set of cover receiver with electrical contacts with the transmission of audio data and power being competed via these single sets of ear cup contact pads and mouth privacy cover receiver with electrical contacts.

In an embodiment, the mouth privacy cover 286 of the headphones 260 may include a touch audio sensor (not shown). The touch audio sensor may be any type of touch controller that receives touch input from the user of the headphones 260 in order to adjust audio characteristics of the audio output from the speakers 276-1. For example, the touch audio sensor may include any capacitive touch, resistive touch, light detector, or other device may be used to detect the user's touch. These adjustments to the audio characteristics of the audio output may include pausing the audio (e.g., via a single touch), increasing a volume of the audio (e.g., via dragging the user's finger over the touch audio sensor in a first direction), decreasing a volume of the audio (.e.g., via dragging the user's finger over the touch audio sensor in a second direction), skipping audio tracks among a plurality of audio tracks (e.g., double tapping the touch audio sensor), and replaying a track (e.g., triple tapping the touch audio sensor). As shown in FIG. 2, the touch audio sensor is not shown, however, it is appreciated that any surface of the adjustable boom portion of the mouth privacy cover may be covered with the touch audio sensor for the user to access and adjust the audio characteristics of the audio output and audio input. It is appreciated that the touch audio sensor may be arranged to receive any type of touch input from the user to adjust the characteristics of the audio output and the present specification contemplates that these other types of touch input at the touch audio sensor by the user. In an embodiment, a number of LED indicators 296 may be formed on the mouth privacy cover 286, for example, next to the touch audio sensor that indicates a status of the adjustments made to the audio output at the speakers 276-1. In an embodiment, the LED indicators 296 may be within physical view of the user as the user wears the headphones 260 so that the user may be made aware of the status of the adjustments to the audio characteristics of the audio output and audio input. In an example embodiment, a series of LED indicators 296 may be arranged next to the touch audio sensor such that successive illumination of the LED indicators 296 indicates a volume level of the audio output at the speakers 276-1.

In an embodiment, the mouth privacy cover 286 includes privacy cover hinges 298 formed on the mouth privacy cover 286 that allow the mouth privacy cover 286 to be angled up or down to align the mouth privacy cover 286 with a user's mouth to cover the user's mouth to prevent the user's voice from being heard. This allows the user's mouth to be covered by the mouth privacy cover 286 so that the ability of others to hear the user's conversation is inhibited or eliminated. In an embodiment, these privacy cover hinges may be formed at or close to a location where the first ear cup contact pads engage with the first cover receiver with electrical contacts and where the second ear cup contact pads engages with the second cover receiver with electrical contacts. In an embodiment, the privacy cover hinges may include an internal space through which electrical leads may be passed from the microphone to the first cover receiver with electrical contacts and second cover receiver with electrical contacts to allow data and power transmission from and to the first cover receiver with electrical contacts and second cover receiver with electrical contacts as described herein.

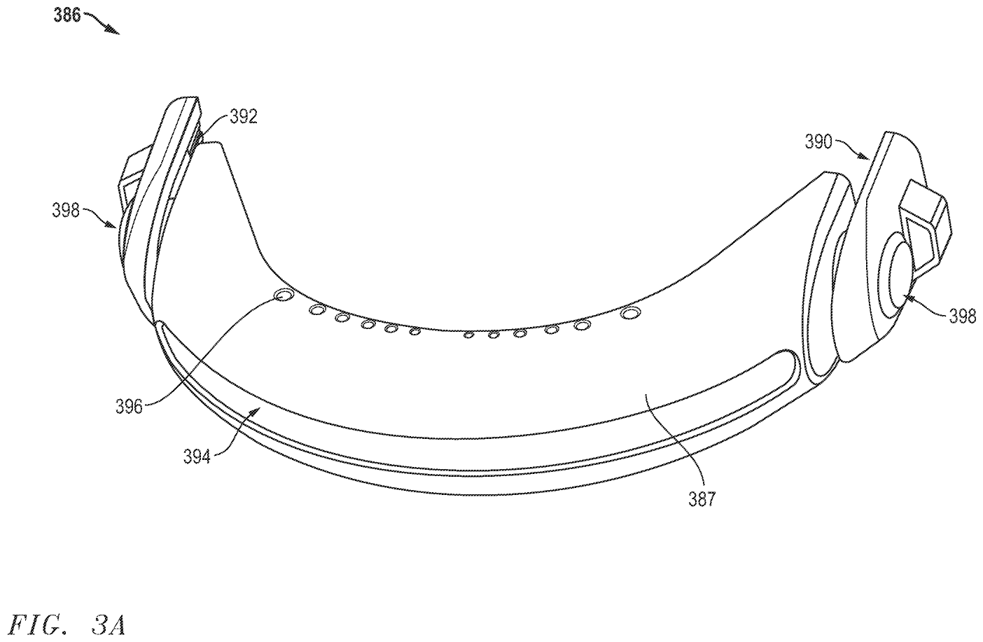

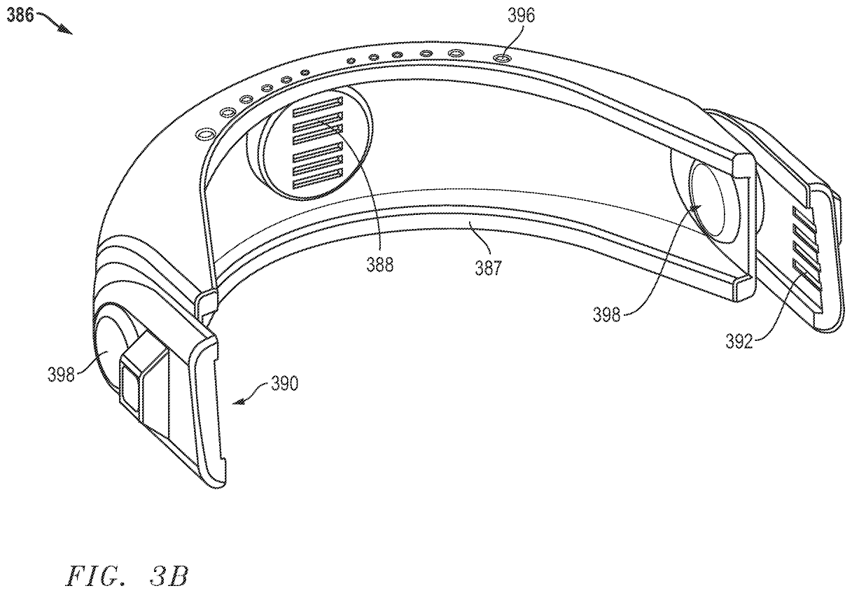

FIG. 3A is a graphic diagram depicting a front perspective view of a mouth privacy cover 386 with an adjustable boom portion 387 operatively couplable to a pair of headphones such as those shown in FIG. 2 according to an embodiment of the present disclosure. Similarly, FIG. 3B is a graphic diagram depicting a rear perspective view of a mouth privacy cover 386 with an adjustable boom portion 387 operatively couplable to a pair of headphones such as those shown in FIG. 2 according to another embodiment of the present disclosure. As described herein, the mouth privacy cover 386 with an adjustable boom portion 387 may be coupled to the headphones such as those shown at 260 in FIG. 2 after the user has put on the headphones or prior to the user putting the headphones on.

As described herein, each of the first ear cup and second ear cup of the set of headphones may include first ear cup contact pads and second ear cup contact pads respectively. Each of the first ear cup contact pads and second ear cup contact pads may be operatively coupled to the DSP of the headphones in order to transmit data from the headphone microphone 388 formed in the adjustable boom portion 387 of the mouth privacy cover 386 to the DSP. Accordingly, the mouth privacy cover 386 includes corresponding first cover receiver with electrical contacts 390 and second cover receiver with electrical contacts 392 that interface with the first ear cup contact pads and second ear cup contact pads, respectively, in order to transmit the audio signals from the headphone microphone 388 to the DSP as well as provide power from the DSP/headphones PMU to the headphone microphone 388 for operating the microphone 388. The first cover receiver with electrical contacts 390 and second cover receiver with electrical contacts 392 may be at the ends of the mouth privacy cover 386 and be a socket, cavity, or attachment space in the side of the mouth privacy cover 386 having electrical contacts. The first cover receiver with electrical contacts 390 and second cover receiver with electrical contacts 392 are formed at one or both ends of the mouth privacy cover such that contact pads of the first or second earcup of the headphones may be removably and operatively coupled within the first cover receiver with electrical contacts 390 or the second cover receiver with electrical contacts 392. In embodiments herein, magnetic, electrical, and mechanical fit may be used to operatively couple the first cover receiver with electrical contacts 390 or second cover receiver with electrical contacts 392 with contact pads of the one or both earcups of the headphones. It is appreciated that engaging the first ear cup contact pads with the first cover receiver with electrical contacts 390 and the second ear cup contact pads with the second cover receiver with electrical contacts 392 may include the use of a latch, magnets, or interference fit structures, or other coupling devices that operatively couples a left side of the mouth privacy cover 386 to the first ear cup and a right side of the mouth privacy cover 386 to the second ear cup. In an embodiment a single set of ear cup contact pads on one earcup of a headset may be used to be operatively coupled to a single set of cover receiver with electrical contacts 390 or 392 with the transmission of audio data and power being completed via these single sets of ear cup contact pads and cover receiver with electrical contacts 390 or 392.

In an embodiment, the adjustable boom portion 387 of the mouth privacy cover 386 may be formed with a crescent or angled shape to reflect and capture a user's voice when situated in front of the user's mouth. Further, the adjustable boom portion 387 of the mouth privacy cover 386 may include a concave interior surface that concentrates the user's voice within the space between the mouth privacy cover and the user's mouth and to the microphone 388. In an embodiment, the size of the adjustable boom portion 387 of the mouth privacy cover 386 may be sufficient to cover the user's mouth when situated in front of the user's mouth so that the user's voice is captured and directed within the space between the mouth privacy cover and the user's mouth to limit sound leakage of the user's voice while the user is talking into the microphone 388. This concave interior surface may also direct the user's voice towards the microphone 388 thereby increasing the audio reception of the microphone 388 in an embodiment. In an embodiment, the adjustable boom portion of the mouth privacy cover may be made of plastic or other lightweight material.

As described in embodiments herein, the adjustable boom portion 387 of the mouth privacy cover 386 of the headphones may include a touch audio sensor 394 as shown and depicted in FIG. 3A. The touch audio sensor 394 may be any type of touch controller that receives touch input from the user of the headphones 360 in order to adjust audio characteristics of the audio output from the speakers in the first and second ear cups. In an example embodiment, the touch audio sensor 394 may include any capacitive touch, resistive touch, light detector, or other device may be used to detect the user's touch. These adjustments to the audio characteristics of the audio output may include pausing the audio (e.g., via a single touch), increasing a volume of the audio (e.g., via dragging the user's finger over the touch audio sensor 394 in a first direction), decreasing a volume of the audio (.e.g., via dragging the user's finger over the touch audio sensor 394 in a second direction), skipping audio tracks among a plurality of audio tracks (e.g., double tapping the touch audio sensor 394), and replaying a track (e.g., triple tapping the touch audio sensor 394). It is appreciated that the touch audio sensor 394 may be arranged to receive any type of touch input from the user to adjust the characteristics of the audio output and the present specification contemplates that these other types of touch input at the touch audio sensor 394 by the user. FIG. 3A shows that the touch audio sensor 394 is placed along a front surface of the mouth privacy cover 386 and may be configured to receive any type of touch input as described herein. In an embodiment, the touch audio sensor 394 may be operatively coupled to the DSP of the headphones via the first cover receiver with electrical contacts 390 or second cover receiver with electrical contacts 392.

In an embodiment, a number of LED indicators 396 may be formed on the adjustable boom portion 387 of the mouth privacy cover 386, for example, next to the touch audio sensor 394 that indicates a status of the adjustments made to the audio output at the speakers. In an example embodiment, a series of LED indicators 396 may be arranged next to the touch audio sensor 394 such that successive illumination of the LED indicators 396 indicates a volume level of the audio output at the speakers. In an embodiment, the LED indicators 396 may be operatively coupled to the DSP of the headphones via the first cover receiver with electrical contacts 390 or second cover receiver with electrical contacts 392.

In an embodiment, the mouth privacy cover 386 includes privacy cover hinges 398 formed on the mouth privacy cover 386 that allow the adjustable boom portion 387 of the mouth privacy cover 386 to be angled up or down to align the adjustable boom portion 387 of the mouth privacy cover 386 with a user's mouth to cover the user's mouth to prevent the user's voice from being heard. In an embodiment, the privacy cover hinges 398 may be spring biased with set hinge angles or may be structured with plastic engagement pieces on two sides of the hinge such that the boom portion of the mouth privacy cover may be stopped or clicked into a plurality of hinge angles, using, for example, a spring or spring system, in order to align the adjustable boom portion 387 in front of a user's mouth. This allows the user's mouth to be covered by the mouth privacy cover 386 so that the ability of others to hear the user's conversation is inhibited or eliminated. In an embodiment, these privacy cover hinges may be formed at or close to a location where the first ear cup contact pads engage with the first cover receiver with electrical contacts 390 and where the second ear cup contact pads engages with the second cover receiver with electrical contacts 392 so the boom portion 387 of the mouth privacy cover may have a wider range of adjustment angles. In an embodiment, the privacy cover hinges may include an internal space through which electrical leads may be passed from the microphone 388, touch audio sensor 394, LED indicators 396, and other components to the first cover receiver with electrical contacts 390 and second cover receiver with electrical contacts 392 to allow data and power transmission from and to the first cover receiver with electrical contacts 390 and second cover receiver with electrical contacts 392 as described herein.

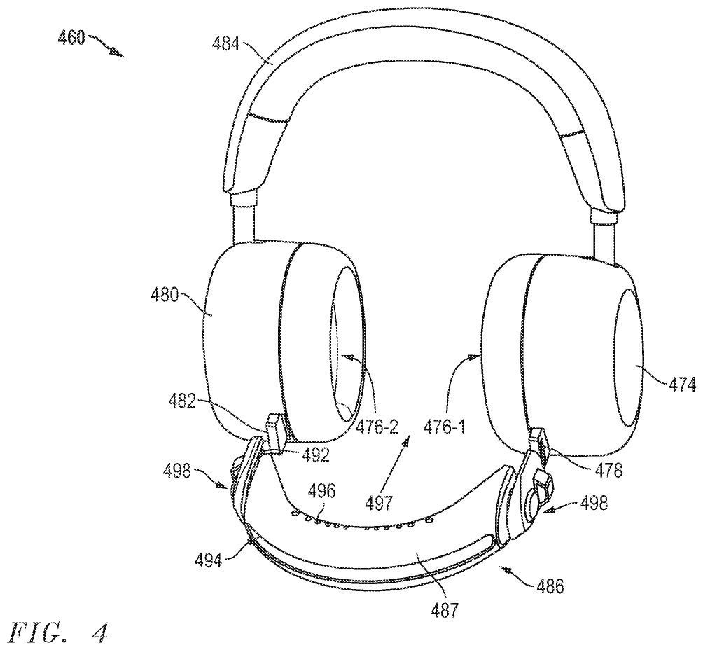

FIG. 4 is a graphic diagram depicting a mouth privacy cover 486 with an adjustable boom portion 487 being operatively coupled to a pair of headphones 460 via one or more contact pads (e.g., 478, 482) and one or more receivers with electrical contacts (e.g., 490, 492) according to another embodiment of the present disclosure. As described herein, the headphones 460 may include a first ear cup 474 and a second ear cup 480 that are to be placed over or onto the user's left and right ears, respectively. In an embodiment, each of the first ear cup 474 and second ear cup 480 may include a first speaker 476-1 and second speaker 476-2, respectively, in order to provide the audio output to the user as described herein. The first ear cup 474 and second ear cup 480 may be operatively coupled to a headband 484 such that, when worn by a user, the headphones 460 may rest on the user's head with the first ear cup 474 and second ear cup 480 positioned onto or over the user's ears as described. In an embodiment, the headband 484 may include an extending portion that allows the distance between a top portion of the headband 484 to be drawn closer or further away from each of the first ear cup 474 and second ear cup 480 thereby allowing a user to customize the fit of the headphones 460 on the user's head.

In an embodiment, each of the first ear cup 474 and second ear cup 480 may include first ear cup contact pads 478 and second ear cup contact pads 482 respectively. Each of the first ear cup contact pads 478 and second ear cup contact pads 482 may be operatively coupled to the DSP of the headphones 460 in order to transmit data from the headphone microphone formed in the mouth privacy cover 486 to the DSP, controls from audio touch sensor 494 to the DSP, and LED indicators 496 from the DSP. Accordingly, the mouth privacy cover 486 may include corresponding first cover receiver with electrical contacts 490 and second cover receiver with electrical contacts 492 that interface with the first ear cup contact pads 478 and second ear cup contact pads 482, respectively, in order to transmit the audio signals from the headphone microphone 488 to the DSP formed in either of the first ear cup 474 or second ear cup 480 as well as provide power from the headphones PMU to the headphone microphone 488. Also, control signals from the audio touch sensor 494 to the DSP and LED indicators 496 from the DSP are facilitated by the first cover receiver with electrical contacts 490 and second cover receiver with electrical contacts 492 that interface with the first ear cup contact pads 478 and second ear cup contact pads 482, respectively. It is appreciated that engaging the first ear cup contact pads 478 with the first cover receiver with electrical contacts 490 and the second ear cup contact pads 482 with second cover receiver with electrical contacts 492 may include the use of a latch, magnets, interference fit structures, or other coupling device that operatively couples a left side of the mouth privacy cover 486 to the first ear cup 474 and a right side of the mouth privacy cover 486 to the second ear cup 480 when the mouth privacy cover 486 is moved to engage with the headphones 460 in the direction of arrow 497. In an embodiment a single set of ear cup contact pads 478 or 482 may be used to be operatively coupled to a single set of cover receiver electrical contacts 490 or 492 with the transmission of audio data, audio touch sensing data, or LED indicator instructions, and power being completed via these single sets of ear cup contact pads 478 or 482 and mouth privacy cover receiver electrical contacts 490 or 492.

In an embodiment, the mouth privacy cover 486 of the headphones 460 may include a touch audio sensor 494 integrated into the housing of the mouth privacy cover 486 as described herein. The touch audio sensor 494 may be any type of touch sensor that receives touch input from the user of the headphones 460 in order to adjust audio characteristics of the audio output from the speakers 476-1, 476-2 formed into the first ear cup 474 and second ear cup 480, respectively. For example, the touch audio sensor 494 may include any capacitive touch, resistive touch, light detector, or other device that may be used to detect the user's touch. These adjustments to the audio characteristics of the audio output may include pausing the audio (e.g., via a single touch), increasing a volume of the audio (e.g., via dragging the user's finger over the touch audio sensor 494 in a first direction), decreasing a volume of the audio (.e.g., via dragging the user's finger over the touch audio sensor 494 in a second direction), skipping audio tracks among a plurality of audio tracks (e.g., double tapping the touch audio sensor 494), and replaying a track (e.g., triple tapping the touch audio sensor 494). It is appreciated that the above touch inputs are examples and that the touch audio sensor 494 may be arranged to receive any type of touch input from the user to adjust any characteristics of the audio output and the present specification contemplates that these other types of touch input may be received as touch audio sensor data at the touch audio sensor 494 from the user. This touch audio sensor data may be sent to the DSP of the headphones 460. In an embodiment, a number of LED indicators 496 may be formed on the mouth privacy cover 486, for example, next to the touch audio sensor 494 but viewable by the user when wearing the mouth privacy cover 486. The LED indicators 496 indicate a status of the adjustments made to the audio output at the speakers 476-1, 476-2 or microphone. In an example embodiment, a series of LED indicators 496 may be arranged next to the touch audio sensor 494 such that successive illumination of the LED indicators 496 indicates a volume level of the audio output at the speakers 476-1, 476-2.

In an embodiment, the mouth privacy cover 486 includes privacy cover hinges 498 formed on the mouth privacy cover 486 that allow an adjustable boom portion 487 of the mouth privacy cover 486 to be angled up or down to align the adjustable boom portion 487 of the mouth privacy cover 486 with a user's mouth to cover the user's mouth to prevent the user's voice from being heard. These privacy cover hinges 498 allow the user to move the adjustable boom portion 487 of the mouth privacy cover 486 so that the user's mouth is covered by the mouth privacy cover 486. The adjustable boom portion 487 of the mouth privacy cover 486 is wide enough to cover a portion of a user's mouth and has a crescent shape from the left to right ends to provide privacy and reflect a user's voice back and toward a microphone in the adjustable boom portion 487. The mouth privacy cover may also have an interior concave shape to further reflect the user's voice back for privacy and funnel the voice towards the integrated microphone in the adjustable boom portion 487 of the mouth privacy cover 486. This gives the user the ability to prevent or reduce the ability others from hearing the user's conversation when providing input to the microphone formed in the adjustable boom portion 497 of the mouth privacy cover 486. In an embodiment, these privacy cover hinges 498 may be formed at or close to a location where the first ear cup contact pads 478 engage with the first cover receiver with electrical contacts 490 and where the second ear cup contact pads 482 engages with the second cover receiver with electrical contacts 492. In an embodiment, the privacy cover hinges 498 may include an internal space through which electrical leads may be passed from the microphone to the first cover receiver with electrical contacts 490 and second cover receiver with electrical contacts 492 to allow data and power transmission from and to the first cover receiver with electrical contacts 490 and second cover receiver with electrical contacts 492 as described herein.

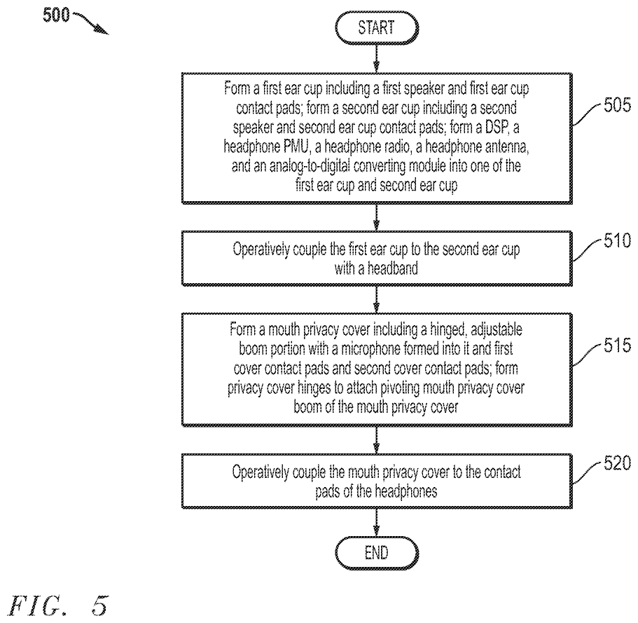

FIG. 5 is a flow chart showing a method 500 of assembling a pair of headphones including a mouth privacy cover according to an embodiment of the present disclosure. The method 500 includes, at block 505, forming a first ear cup including a first speaker and first ear cup contact pads. As described herein, the first speaker is oriented into the first ear cup such that audio output is provided to the user at a first ear of the user (e.g., a left ear). Additionally, the first ear cup contact pads may be used to operatively couple the first ear cup to a microphone formed into the mouth privacy cover as described herein. Additionally, at block 505, the method 505 also includes forming a second ear cup including a second speaker and second ear cup contact pads. Similarly, the second speaker is oriented into the second ear cup such that audio output is provided to the user at a second ear of the user (e.g., a right ear). Additionally, the second ear cup contact pads may be used to operatively couple the first ear cup to a microphone formed into the mouth privacy cover as described herein.

Block 505 of the method 500 also includes forming a DSP, a headphone PMU, a headphone radio, a headphone antenna, and an analog-to-digital converting module into one of the first ear cup and second ear cup. As described herein, either or both of the first ear cup and second ear cup may have some or all of the DSP, the headphone PMU, the headphone radio, the headphone antenna, and the analog-to-digital converting module formed therein. In an example embodiment, a printed circuit board (PCB) may be formed into either or both of the first ear cup and second ear cup that includes any number of electrical connections and circuitry that operatively couples the DSP to the headphone PMU, the headphone radio, the headphone antenna, and the analog-to-digital converting module to perform the operations described herein. These operations include, for example, pairing the headphones to an information handling system, converting analog audio data into a digital format for transmission to the information handling system using the headphone radio and headphone antenna. In an embodiment, the one or more of the DSP, headphone PMU, headphone radio, headphone antenna, and analog-to-digital converting module are formed into either of the first ear cup and second ear cup, and either or both the first ear cup and second ear cup may include the first ear cup contact pads and the second ear cup contact pads formed thereon electrically and operatively coupled to the PCB having the DSP, the headphone PMU, the headphone radio, the headphone antenna, and the analog-to-digital converting module formed in those ear cups.

At block 510, the method 500 includes operatively coupling the first ear cup to the second ear cup with a headband. The first ear cup and second ear cup may be operatively coupled to a headband via one or more headband connector shafts that are attached, fastened, or otherwise coupled to the first ear cup or second ear cup such that, when worn by a user, the headphones may rest on the user's head with the first ear cup and second ear cup positioned onto or over the user's ears as described. In an embodiment, the headband may include an extending portion that allows the distance between a top portion of the headband to be drawn closer or further away from each of the first ear cup and second ear cup thereby allowing a user to customize the fit of the headphones on the user's head.

At block 515, the method 500 may include forming a mouth privacy cover including a microphone formed into an adjustable boom portion of the mouth privacy cover. In various embodiments, the mouth privacy cover may be of a crescent shape, angled shape, or other suitable shape to reflect a user's voice back into a space between the mouth privacy cover and the user's mouth when worn to limit the projection of the user's voice when speaking into the microphone. The mouth privacy cover includes a first cover receiver with electrical contacts or second cover receiver with electrical contacts at the left and right ends of the mouth privacy cover. The first cover receiver with electrical contacts or second cover receiver with electrical contacts are a socket, cavity, receiver space in the wall of the mouth privacy cover or other receiving structure with electrical contacts to operably couple with the contact pads of one or more earcups of the headphones. As described herein, the first cover receiver with electrical contacts may be formed on a first end of the mouth privacy cover (e.g., a left side of the mouth privacy cover) and the second cover receiver with electrical contacts may be formed on a second end of the mouth privacy cover (e.g., a right side of the mouth privacy cover). These cover receiver with electrical contacts may be arranged on the mouth privacy cover such that when the user couples the mouth privacy cover to the headphones, the first ear cup contact pads engage with the first cover receiver with electrical contacts and the second ear cup contact pads engage with the second cover receiver with electrical contacts. Further, the first cover receiver with electrical contacts and second cover receiver with electrical contacts may be magnetic to magnetically engage with contact pads of the earcups of the headphones in some embodiments.

In an embodiment, at block 515, a set of privacy cover hinges may be formed on the mouth privacy cover. In an embodiment, the privacy cover hinges formed on the mouth privacy cover allow the adjustable boom portion of the mouth privacy cover to be angled up or down to align the adjustable boom portion of the mouth privacy cover with a user's mouth to cover the user's mouth to prevent the user's voice from being heard. These privacy cover hinges may be spring biased in some embodiments. In other embodiments, the privacy cover hinges may include plastic or other material form with edges or notches to allow for a plurality of angles for the adjustable boom portion of the mouth privacy cover to be set.

In an embodiment, the adjustable boom portion of the mouth privacy cover may include a concave interior surface that concentrate the user's voice within the space between the mouth privacy cover and the user's mouth. In an embodiment, the size of the adjustable boom portion of the mouth privacy cover may be sufficient to cover the user's mouth when aligned with the user's mouth so that the user's voice is captured and directed within the space between the mouth privacy cover and the user's mouth to limit sound leakage of the user's voice while the user is talking. This concave interior surface may also direct the user's voice towards the microphone thereby increasing the audio reception of the microphone in an embodiment. In an embodiment, the adjustable boom portion of the mouth privacy cover may be made of plastic or other lightweight material. This allows the user's mouth to be covered by the mouth privacy cover so that the ability of others to hear the user's conversation is inhibited or eliminated.

At block 520, the method 500 includes operatively coupling the mouth privacy cover to the headphones. This is done by engaging the first ear cup contact pads with the first cover receiver with electrical contacts and the second ear cup contact pads with the second cover receiver with electrical contacts. It is appreciated that engaging the first ear cup contact pads with the first cover receiver with electrical contacts and the second ear cup contact pads with the second cover receiver with electrical contacts may include the use of a latch, reciprocal magnetic engagements, interference fit structures, or other coupling device that operatively couples a left side of the mouth privacy cover to the first ear cup and a right side of the mouth privacy cover to the second ear cup when the mouth privacy cover is engaged with the headphones. At this point, the method 500 may end.

The blocks of the flow diagram of FIG. 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A set of audio headphones operatively coupled to an information handling system, comprising:
a digital signal processor (DSP);
a headphone power management unit (PMU) to provide power to the DSP;
a first ear cup with a first speaker and a second ear cup with a second speaker operatively coupled to each other via a headband; and
a mouth privacy cover having an integrated microphone and operatively coupled to the first ear cup at a first end of the mouth privacy cover and operatively coupled to the second ear cup at a second end of the mouth privacy cover, the mouth privacy cover having a microphone built into the mouth privacy cover and operatively coupled to the DSP via a cover receiver with electrical contacts formed on the mouth privacy cover and interfacing with ear cup contact pads formed on at least one of the first ear cup and second ear cup.

2. The set of audio headphones of claim 1 further comprising:
a touch audio sensor formed on a housing of the mouth privacy cover to receive touch input from a user to adjust audio characteristics of the audio output from the first speaker and second.

3. The set of audio headphones of claim 1 further comprising:
one or more light-emitting diode (LED) indicators formed into a housing of the mouth privacy cover to be visible by the user to indicate to the user a status of the adjustments to audio characteristics of audio output to the first speaker and second speaker or the integrated microphone.

4. The set of audio headphones of claim 1 further comprising:
the first ear cup comprising first ear cup contact pads and the second ear cup comprising second ear cup contact pads to interface with a first cover receiver with electrical contacts and a second cover receiver with electrical contacts of the mouth privacy cover to transmit audio data from the microphone to the DSP.

5. The set of audio headphones of claim 1 further comprising:
a headphone radio to wirelessly couple the set of audio headphones to the information handling system.

6. The set of audio headphones of claim 1 further comprising:
a latch formed on at least one side of the mouth privacy cover to latch the at least one side of the mouth privacy cover to at least one of the first ear cup and second ear cup.

7. The set of audio headphones of claim 1 further comprising
the mouth privacy cover including hinges that allow and adjustable boom portion of the mouth privacy cover to be angled up or down to align the adjustable boom portion of the mouth privacy cover with a user's mouth to cover the user's mouth to prevent the user's voice from being heard.

8. A wireless set of headphones, comprising:
a digital signal processor (DSP); and
a headphone radio to wirelessly couple the set of headphones to an information handling system;
a first speaker disposed in a first ear cup and a second speaker disposed in a second ear cup to provide audio output to a user;
a mouth privacy cover operatively coupled to the first ear cup at a first end of the mouth privacy cover having a crescent shape to reflect a user's voice back to a space between the mouth privacy cover and the user's mouth when the wireless set of headphones are worn;
a microphone formed into the mouth privacy cover to receive audio input from the user;
a headphone power management unit (PMU) to provide power to the DSP, the first speaker, the second speaker, and the microphone;
a mouth privacy cover receiver with electrical contacts formed on the mouth privacy cover and removably and operatively coupled to ear cup contact pads formed on the first ear cup to operatively couple the microphone to the DSP; and
the mouth privacy cover including hinges for an adjustable boom portion of the mouth privacy cover to be angled up or down to align the mouth privacy cover with a user's mouth to cover the user's mouth to prevent the user's voice from being heard.

9. The wireless set of headphones of claim 8 further comprising:
a second mouth privacy cover receiver with electrical contacts at a second end of the mouth privacy cover removably and operatively coupled to a second ear cup via ear cup contact pads formed on the second ear cup.

10. The wireless set of headphones of claim 8 further comprising:
a touch audio sensor formed on a housing of the mouth privacy cover and operatively coupled to the DSP to receive touch input from a user to adjust audio characteristics of the audio output the first speaker and the second speaker.

11. The wireless set of headphones of claim 8 further comprising:
one or more light-emitting diode (LED) indicators formed into a housing of the mouth privacy cover to indicate to the user a status of adjustments to audio characteristics of the audio output received from the DSP for the first speaker and the second speaker.

12. The wireless set of headphones of claim 9 further comprising:
the first ear cup comprising first ear cup contact pads with a first magnet to magnetically interface with first cover receiver with electrical contacts to magnetically couple with the first ear cup contact pads to transmit audio data from the microphone to the DSP.

13. The wireless set of headphones of claim 7 further comprising:
the mouth privacy cover including hinges that allow an adjustable boom portion of the mouth privacy cover to be angled up or down to align the adjustable boom portion of the mouth privacy cover with a user's mouth to cover the user's mouth.

14. A pair of headphones comprising:
a first ear cup;
a second ear cup;
a headband operatively coupled to the first ear cup to a first end of the headband and the headband operatively coupled to the second ear cup to a second end of the headband;
a mouth privacy cover operatively coupled to the first ear cup at a first end of the mouth privacy cover and operatively coupled to the second ear cup at a second end of the mouth privacy cover, the mouth privacy cover including hinges that allow an adjustable boom portion of the mouth privacy cover having an integrated microphone to be angled up or down to align the mouth privacy cover with a user's mouth, where the adjustable boom portion has a crescent shape to cover the user's mouth to reduce the user's voice when speaking.

15. The pair of headphones of claim 14 further comprising:
a touch audio sensor formed on a housing of the mouth privacy cover and operatively coupled to a digital signal processor (DSP) to receive touch input from a user to adjust audio characteristics of audio output from one or more speakers formed into the first ear cup and the second ear cup respectively.

16. The pair of headphones of claim 14 further comprising:
one or more light-emitting diode (LED) indicators formed into a housing of the mouth privacy cover to indicate to the user a status of the adjustments to the audio characteristics of audio output from one or more speakers formed into the first ear cup and the second ear cup and of audio input from the microphone.

17. The pair of headphones of claim 14 wherein the adjustable boom portion has a concave interior shape reflect the user's voice back to the space between the mouth privacy cover and the user's mouth to reduce the user's voice when speaking.

18. The pair of headphones of claim 14 further comprising:
the first ear cup comprising first ear cup contact pads with a first magnet and the second ear cup comprising second ear cup contact pads with a second magnet to magnetically interface with first cover receiver with electrical contacts having magnetic engagement with the first ear cup contact pads and second cover receiver with electrical contacts having magnetic engagement with the second ear cup contact pads, respectively, to transmit audio data from the microphone to the DSP.

19. The pair of headphones of claim 14 further comprising:
a latch formed on a first side of the mouth privacy cover to latch the first side of the mouth privacy cover to the first ear cup.

20. The pair of headphones of claim 14 further comprising:
the adjustable boom portion including a spring that is biased to set an angle of the adjustable boom portion of the mouth privacy cover at a specific angle when the adjustable boom portion is moved to cover the user's mouth when worn.
